(19) United States
(12) Patent Application Publication
(10) Pub. No.: US 2013/0246435 A1
(43) Pub. Date: Sep. 19, 2013

(54) FRAMEWORK FOR DOCUMENT KNOWLEDGE EXTRACTION

(71) Applicants: Jun Yan, Beijing (CN); Lei Ji, Beijing (CN); Edward W. Wild, Seattle, WA (US); Yi Li, Issaquah, WA (US); Ning Liu, Beijing (CN); Zheng Chen, Beijing (CN)

(72) Inventors: Jun Yan, Beijing (CN); Lei Ji, Beijing (CN); Edward W. Wild, Seattle, WA (US); Yi Li, Issaquah, WA (US); Ning Liu, Beijing (CN); Zheng Chen, Beijing (CN)

(73) Assignee: MICROSOFT CORPORATION, Redmond, WA (US)

(21) Appl. No.: 13/419,690

(22) Filed: Mar. 14, 2012

(51) Int. Cl. G06F 17/30

(52) U.S. Cl. 707/741; 707/736; 707/748; 707/E17.002; 707/E17.046

(57) ABSTRACT

A knowledge extraction framework may iteratively enrich an ontology that is used to classify structured knowledge obtained from web pages based on structured knowledge previously acquired from other web pages. The framework may enable a user to define the ontology for extracting structured knowledge from a plurality of web pages. The framework applies the ontology using a supervised extraction algorithm to extract seed information from a set of web pages. The framework further applies an unsupervised extraction algorithm to extract the structured knowledge from an additional set of web pages. The framework subsequently maps the structured knowledge to the ontology based on the seed information to enrich the ontology.

### BACKGROUND

Structured knowledge that is extracted from semi-structured web pages may enable search engines to directly answer search queries from users rather than provide a list of ranked search results. Semi-structured web pages may be web pages that contain data that are organized according to a common schema. For example, web pages of a movie review website in which each web page lists a title of a corresponding movie, a release date of the corresponding movie, a director of the corresponding movie, and a review of the corresponding movie may be considered semi-structured web pages. The structured knowledge may be in the form of entities and attributes. In the movie review website example, the entities may the movies, and the titles of movies that are extracted from the semi-structured web pages of the movie review website may be the attributes of the entities. A search engine may also use the structured knowledge that is extracted from the semi-structured web pages to annotate such web pages so that the ability of the search engine to retrieve relevant results may be improved.

The extraction of structured knowledge from semi-structured web pages may rely on the human annotation of at least some of these semi-structured web pages. However, given the number of semi-structured web pages that are available online today, a human annotator may be faced with an impractical task of having to annotate tens of thousands of web pages. Further, semi-structured web pages of different websites do not generally share the same data structure, and the data structures of semi-structured web pages may be changed by web developers at any time, even as structured knowledge is being extracted.

### SUMMARY

Described herein are techniques for extracting structured knowledge from semi-structured web pages. The techniques enable the semi-automatic extraction of the structured knowledge with minimal human input. Further, the techniques may automatically adapt to changes in the data structures of the semi-structured web pages during extraction. The techniques rely on a framework that bootstraps a supervised knowledge extraction algorithm with an unsupervised knowledge extraction algorithm to provide an iterative approach for extracting structured knowledge from semi-structured web pages.

Accordingly, the framework may leverage the supervised and the unsupervised knowledge extraction algorithms to iteratively improve the ontology that is used to classify knowledge obtained from each new web page based on knowledge obtained from previous web pages. As a result, the framework may have the ability to adapt to data structure changes and/or new data structures of semi-structured web pages during structured knowledge extraction.

In at least one embodiment, the framework may enable a user to define an ontology for extracting structured knowledge from a plurality of web pages. The framework applies the ontology using a supervised extraction algorithm to extract seed information from a set of web pages. The framework further applies an unsupervised extraction algorithm to extract the structured knowledge from an additional set of web pages. The framework subsequently maps the structured knowledge to the ontology based on the seed information to enrich the ontology.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram that illustrates an example scheme that implements a knowledge extraction framework that extracted structured knowledge from semi-structured web pages to enrich an ontology.

FIG. 2 is an illustrative diagram that shows example modules of a knowledge extraction framework.

FIG. 3 is an illustrative diagram that shows the example components of a mapping module included in the knowledge extraction framework.

FIG. 4 is a flow diagram that illustrates an example process for enriching the ontology that is used to extract structured knowledge from semi-structured web pages.

FIG. 5 is a flow diagram that illustrates an example process for mapping extracted entities to the ontology to enrich the ontology.

FIG. 6 is a flow diagram that illustrates an example process for determining overlapping seed entities that provide seed information for mapping the extracted entities to the ontology.

### DETAILED DESCRIPTION

Described herein are techniques for extracting structured knowledge from semi-structured web pages. The techniques enable the semi-automatic extraction of the structured knowledge with minimal human input. Further, the techniques may automatically adapt to changes in the data structures of the semi-structured web pages during extraction. The techniques rely on a framework that bootstraps a supervised knowledge extraction algorithm with an unsupervised knowledge extraction algorithm to provide an iterative approach for extracting structured knowledge from semi-structured web pages.

In operation, the supervised knowledge extraction algorithm may use an ontology that is predefined by a human annotator to extract seed information from one or more seed websites. On the other hand, the unsupervised knowledge extraction algorithm may extract columns of knowledge from multiple semi-structured websites without human input. The framework may then map the extracted knowledge to the predefined ontology based on training data in the form of the seed information extracted by the supervised knowledge extraction algorithm. Subsequently, the framework may use the mapped knowledge provided by the unsupervised knowledge extraction algorithm to enrich the metadata of the ontology, so that the enriched ontology may be used to extract structured information from additional semi-structured websites.

Accordingly, the framework may leverage the supervised and the unsupervised knowledge extraction algorithms to iteratively improve the ontology that is used to classify knowledge obtained from each new semi-structured web page based on knowledge obtained from previous semi-structured web pages. As a result, the framework may have the ability to adapt to data structure changes and/or new data structures of semi-structured web pages during structured knowledge extraction.

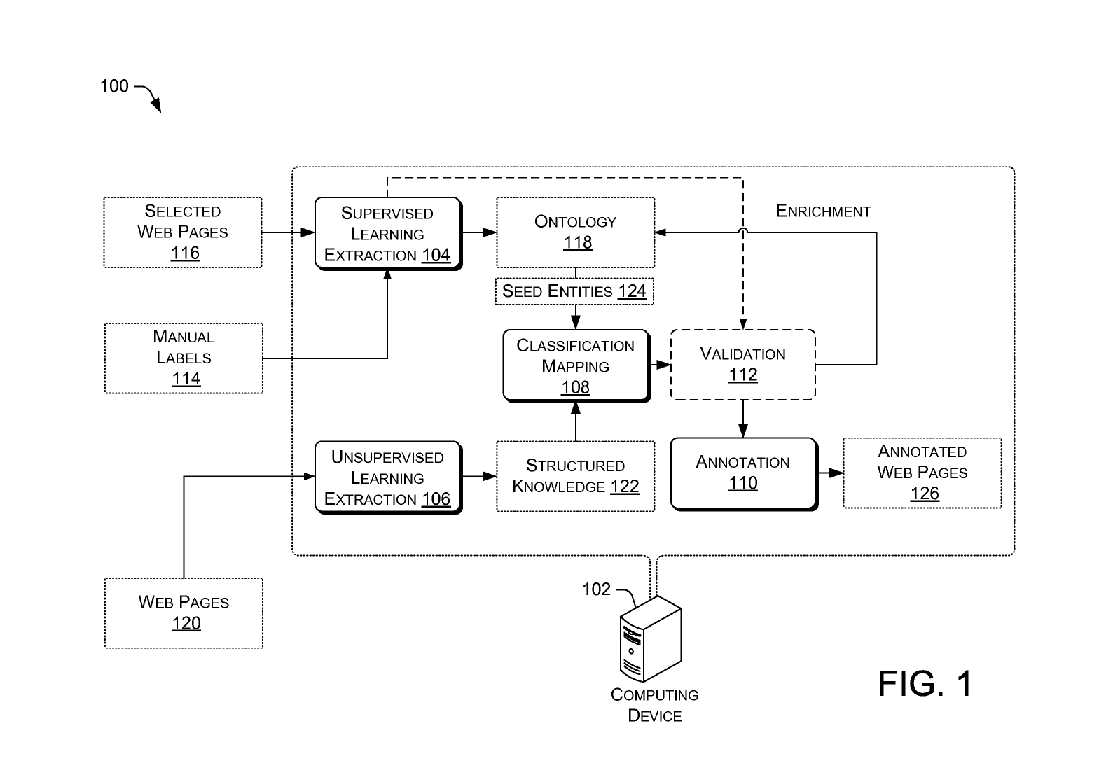

The structured knowledge that is extracted from each semi-structured web page may be used to annotate the web page. The annotation of the semi-structured web pages may assist a search engine in retrieving relevant web pages in response to a search query. Various examples of techniques for implementing a framework that extracts structured knowledge from semi-structured web pages to enrich an ontology in accordance with the embodiments are described below with reference to FIGS. 1-6.

### Example Scheme

FIG. 1 is a block diagram that illustrates an example scheme 100 for enriching an ontology using extracting structured knowledge from semi-structured web pages. The semi-structured web pages may be web pages that are published on the Internet, available through an intranet, and/or stored on any form of electronic media. The example scheme 100 may be implemented by a computing device 102. The example scheme 100 may include supervised learning knowledge extraction 104, unsupervised learning knowledge extraction 106, classification mapping 108, and annotation 110. In some embodiments, the example scheme 100 may also include validation 112.

The supervised learning knowledge extraction 104 may use manual labels 114 that are inputted by a user. For example, the user may label each of one or more web pages of a movie review website as containing particular attributes and attribute values. In such an example, the user may label a first portion of a particular web page as showing a title of a corresponding movie, a second portion of the particular web page as showing a release data of the movie, a third portion of the particular web page as showing a director name for the movie, a fourth portion of the particular web page as showing a review of the movie, and/or so forth.

The manual labeling information may be used as rules for extracting knowledge from selected web pages 116. For example, once the user has manually labeled a few web pages of the movie review website, a supervised learning algorithm may apply the rules and automatically extract titles, release dates, director names, reviews, and/or so forth from other web pages of the movie review website. In other words, the manual labeling information may provide an ontology 118, which is a classification structure for classifying attributes and attribute values. For example, an illustrative ontology used to extract knowledge from movie review websites that belong to a movie domain may be as follows:

Movie
Movie Title
Movie Release Date
   In theater
   On DVD
Movie Director
   Director1
   Director2

The information that is extracted from the selected web pages 116 may be organized as attribute names and attribute values. For example, “movie title: Avatar” may be an attribute name and attribute value for an entity that is a movie. As described below, attribute names and attribute values of entities that are obtained via supervised learning knowledge extraction 104 may further serve as training data.

The unsupervised learning knowledge extraction 106 may include the use of an unsupervised knowledge extraction algorithm to extract structured knowledge 122 from the web pages 120. In various embodiments, the web pages 120 may include the selected web pages 116 and/or additional web pages that belong in the same domain, i.e., subject category, as the web pages 116. The web pages 120 may be from the same website as the selected web pages 116 and/or from additional websites. During the extraction of the structured knowledge 122 from the web pages 120, the unsupervised knowledge extraction algorithm may compare the web pages 120 to determine differences between the web pages 120.

By making such comparisons, the unsupervised knowledge extraction algorithm may discover variant parts and invariant parts of the web pages 120. The variant parts are portions of the web pages 120 that vary across the web pages 120, while the invariant parts are portions of the web pages 120 that are uniform across the web pages 120. Accordingly, the comparisons may reveal structured knowledge 122 that may be extracted from the web pages, in which the invariant parts may include attribute names and the variant parts may include attributes values.

The structured knowledge 122 may be organized into the form of a table that includes rows and columns, in which each row includes information for an extracted entity. Each row may include information that is organized into attribute columns. For example, an extracted entity may be a particular movie, and the row for the entity may include a first column entry that includes a title of the movie, a second column that includes a release date of the movie, a third column entry that includes a director name for the movie, and/or so forth.

The classification mapping 108 may map the structured knowledge 122 produced by the unsupervised learning knowledge extraction 106 to the ontology 118 using the seed entities 124. As described above, the seed entities 124 may be generated by the supervised learning knowledge extraction 104. In some embodiments, the mapping of the structured knowledge 122 to the ontology 118 may be validated through the optional validation 112. The validation 112 may include the comparison of the structured knowledge 122 against the seed entities 124 to determine validity of the data extracted by the unsupervised learning extraction 106, or the random manual sampling and checking of a predetermined percentage of the structured knowledge 122 for validity of the extracted data.

Accordingly, assuming that the validation 112 confirms that the mapping of the structured knowledge 122 to the ontology 118 is valid, the ontology 118 may be enriched by the structured knowledge 122. In some embodiments, the classification mapping 108 may also be followed by annotation 110, which annotates the structured knowledge 122 back into the web pages 120 to produce annotated web pages 126.

### Computing Device Components

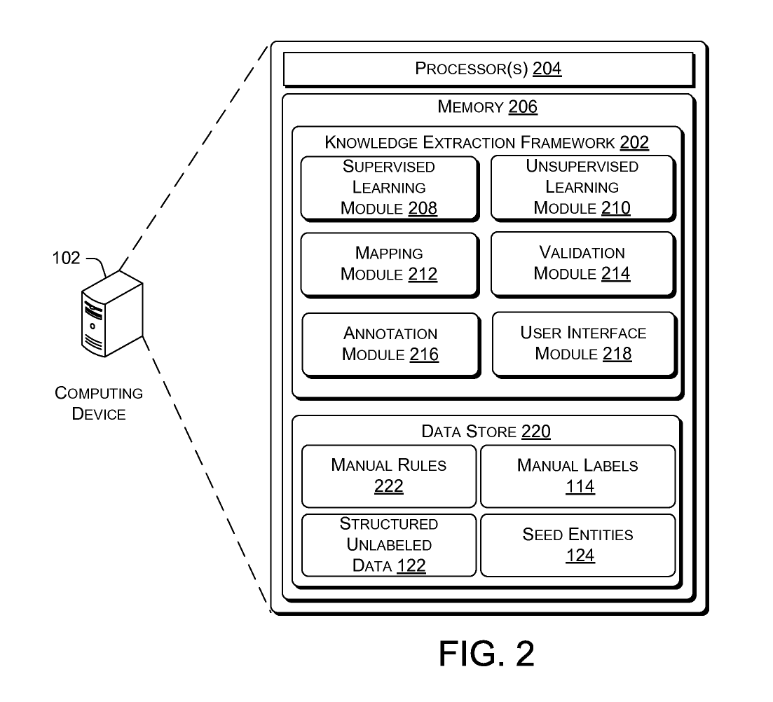

FIG. 2 is an illustrative diagram that shows the example components of a knowledge extraction framework 202. The knowledge extraction framework 202 may be implemented by the computing device 102. In various embodiments, the computing device 102 may be a general purpose computer, such as a desktop computer, a tablet computer, a laptop computer, one or more servers, and so forth. However, in other embodiments, the computing device 102 may be one of a smart phone, a game console, a personal digital assistant (PDA), or any other electronic device that interacts with a user via a user interface.

The computing device 102 may includes one or more processors 204, memory 206, and/or user controls that enable a user to interact with the computing device. The memory 206 may be implemented using computer readable media, such as computer storage media. Computer-readable media includes, at least, two types of computer-readable media, namely computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media. The computing device 102 may have network capabilities. For example, the computing device 102 may exchange data with other electronic devices (e.g., laptops computers, servers, etc.) via one or more networks, such as the Internet.

The one or more processors 204 and the memory 206 of the computing device 102 may implement components of the knowledge extraction framework 202. The knowledge extraction framework 202 may include a supervised learning module 208, an unsupervised learning module 210, a mapping module 212, a validation module 214, an annotation module 216, and a user interface module 218. The memory 206 may also implement a data store 220.

The supervised learning module 208 may perform the supervised learning knowledge extraction 104 on the selected web pages 116 based on the manual labels 114. Accordingly, the supervised learning module 208 may produce the ontology 118 and the seed entities 124. Likewise, the unsupervised learning module 210 may performed the unsupervised learning knowledge extraction 106 on the web pages 120 to produce the structured knowledge 122.

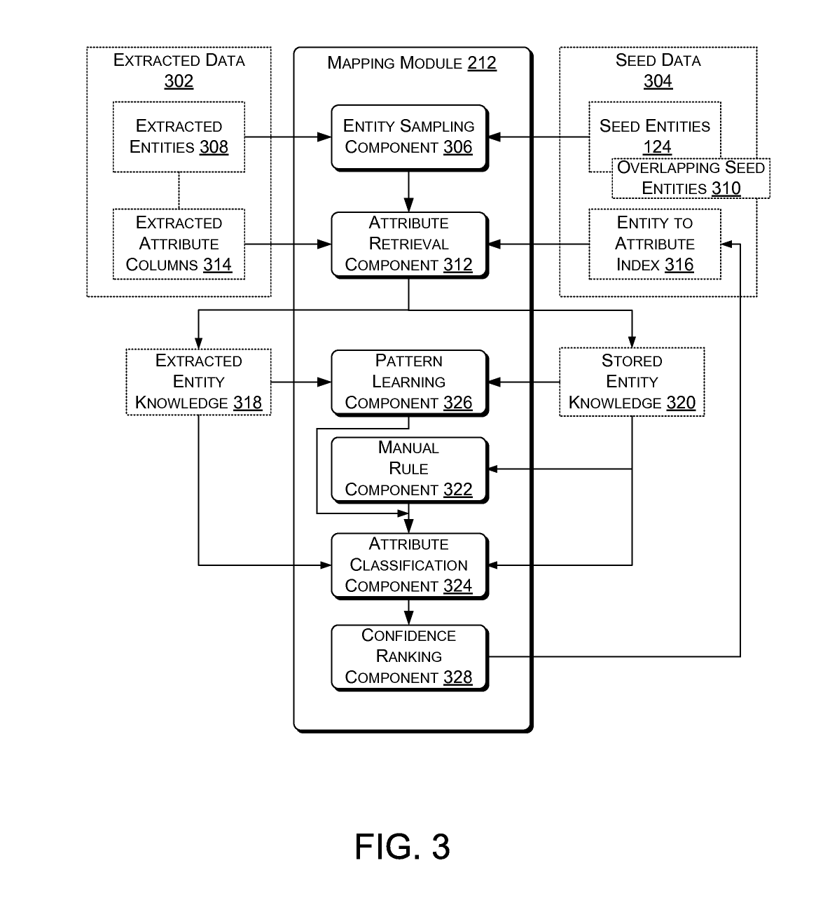

The mapping module 212 may apply the classification mapping 108 to map the structured knowledge 122 to the ontology 118 based on the seed entities 124. Thus, the mapping may involve the classification of the structured knowledge 122 to the ontology 118 based on training data in the form of the seed entities 124. Such classification enriches the ontology 118 with additional knowledge. Accordingly, by using the enriched ontology 118, a search engine may improve the extraction of knowledge from different websites. The example components and the example operations of the mapping module 212 are further illustrated in FIG. 3.

FIG. 3 is an illustrative diagram that shows the example components of the mapping module 212 that is included in the knowledge extraction framework 202. As shown, the mapping module 212 may process the extracted data 302 and the seed data 304. The extracted data 302 may comprise data from the structured knowledge 122. In various embodiments, the mapping module 212 may perform operations with respect to extracted entities 308 in the structured knowledge 122. The seed data 304 may include the seed entities 124.

In operation, the mapping module 212 may receive a large number of seed entities 124, which may make the mapping of the structured knowledge 122 to the ontology 118 a time consuming proposition. Accordingly, the entity sampling component 306 of the mapping module 212 may sample the seed entities 124 and the extracted entities 308 to find one or more seed entities 124 that overlap with corresponding extracted entities 308. A seed entity overlaps when the seed entity has a corresponding counterpart entity in the extracted entities 308, although the seed entity and the counterpart entity may have different attributes and/or attribute values. For example, the seed entity “Windows 7” may be an overlapping seed entity when the entity sampling component 306 is able to locate a corresponding “Windows 7” entity in the extracted entities 308. The mapping module 212 may then use the attribute names and attribute values of overlapping seed entities 310 for mapping of the structured knowledge 122 to the ontology 118.

In at least one embodiment, the number of overlapping seed entities 310 to be found by the entity sampling component 306 may be manually defined. Such manual definition may include the designation of a lower bound and an upper bound for the number of the overlapping seed entities 310. Subsequently, the entity sampling component 306 may search the extracted entities 308 and the seed entities 124 for the overlapping seed entities 310. In the event that the number of the overlapping seed entities 310 found after a complete search of the extracted entities 308 and the seed entities 124 does not at least meet the lower bound, the entity sampling component 306 may determine that the web pages that provided the extracted entities 308 are not suitable for knowledge extraction in order to enrich the ontology 118. Alternatively, the entity sampling component 306 may stop searching for overlapping seed entities 310 after sampling all the extracted entities 308 or when the number of the overlapping seed entities 310 found meets the upper bound.

In some embodiments, the entity sampling component 306 may use exact matching or strict substring matching to find the overlapping seed entities 310. For example, “iPhone 4” may be match with “iphone 4” and “iphone 4 (AT&T)”. However, “iPhone 4” may be excluded from being matched to “iPhone”. Such precise matching may prevent the generation of noise that is associated with other matching techniques when matching product names, such as noise that is generated by edit distance matching techniques.

The attribute retrieval component 312 may retrieve data from both entities in the extracted data 302 and the seed data 304. With respect to the extracted data 302, the attribute retrieval component 312 may retrieve attribute values from extracted attribute columns 314. The extracted attribute columns 314 are attribute columns in the one or more entities of the extracted entities 308. The attribute values in the extracted attribute columns 314 may be data samples that are to be classified into the ontology 118. Accordingly the attribute values from the extracted attribute columns 314 may be referred to as the extracted entity knowledge 318.

Further, the attribute retrieval component 312 may retrieve the attribute names and attributes values of the one or more overlapping seed entities 310 from the seed entities 124. In some embodiments, the attributes of the one or more overlapping seed entities 310 may be directly loaded for classification. However, in embodiments in which the data scale of the attributes exceeds a predetermined data scale threshold, the attribute retrieval component 312 may build an entity-to-attribute index 316 that correlates the overlapping seed entities 310 to their attributes. The attribute names and attribute values of the overlapping seed entities 310 may be referred to as the stored entity knowledge 320. The classes for classification are the attribute names of the one or more overlapping seed entities 310.

The manual rule component 322 may enable a user to input one or more rules that are used by the attribute classification component 324 to classify the extracted entity knowledge 318 into the ontology 118 based on the stored entity knowledge 320. The rules may reflect human knowledge or insight about the seed entities 124. For example, the user may input a string mapping rule that states “Tom Hanks” and “T. Hanks” may be considered as the same if they are attributes of the same entity from different data sources.

In other embodiments, the user may also manually define one or more regular expressions for classifying attributes in the ontology 118. A regular expression may provide flexible parameters for specifying and matching strings of texts, such as characters, words, or patterns of characters. For example, a regular expression may be used to classify dates and times, such as movie release dates and times, regardless of date and time formats. In additional embodiments, the user may also define taxonomies for attribute types that are used for classification. For example, an example attribute type taxonomy may be defined as follows:

Numerical Attributes
Pure numerical value
   Patterned numerical attributes (e.g., date, time)
   Non-patterned numerical attribute (e.g. movie rating)
Numerical value with unit of measure (e.g., price)
   Unit of measure by symbol (e.g., $)
   Unit of measure by text (e.g., pixel)

Enumerable Attributes
Boolean (e.g., Yes/No)
Close List (e.g., color of car)
Open List (e.g., actor of Movie)

Free Text Attributes
Metric measurable
   Short text (e.g., keywords)
   Long text (e.g., movie description)
Metric un-measurable (e.g., user review for a movie)

The pattern learning component 326 may generate one or more pattern rules that are used by the attribute classification component 324 to classify the extracted entity knowledge 318 into the ontology 118 based on the stored entity knowledge 320. The pattern learning component 326 may use machine learning to automatically determine the pattern rules. For example, sample attributes from the extracted entity knowledge 318 and the stored entity knowledge 320 are given below, in which the attribute “Movie Length” is from the stored entity knowledge 320 and the attribute “Unknown” is from the extracted entity knowledge 318, and each attribute has an attribute column that lists attribute values from a plurality of corresponding entities (e.g., entity 1 and entity 2):

| | Movie Length | Unknown | Pattern |
|---|---|---|---|
| Entity 1 | 1.5 Hr | 90 min | 90/1.5 = 60 |
| Entity 2 | 2 Hr | 120 min | 120/2 = 60 |
| . . . | . . . | . . . | |

In such a scenario, the pattern learning component 326 may discover a pattern that indicates Unknown/Movie Length=60 for each of the entities. Thus, since the pattern produces a constant value for each entity, the pattern may indicate that the attribute that is unknown is actually equivalent to the attribute “Movie Length”.

The attribute classification component 324 may map the attributes of the extracted entities 308 by classifying the extracted entity knowledge 318 to the ontology 118 based on the stored entity knowledge 320. In various embodiments, the attribute classification component 324 may use exact matching, the manual rules, and the learned pattern rules to produce precise mapping of the extracted entity knowledge 318 to the ontology 118. In some embodiments, the attribute classification component 324 may use Cosine similarity matching for classifying the “long text type” attribute specified in an attribute type taxonomy.

The confidence ranking component 328 may evaluate the mapping of the one or more attributes to the ontology 118 to determine whether each attribute is confidently classified. For example, if all the entities corresponding to an attribute are well matched to the ontology 118, then the confidence ranking component 328 may determine that the attribute is confidently classified. Otherwise, the confidence ranking component 328 may determine that the attribute has not been confidently classified and the mapping of the attribute to the ontology 118 may be discarded.

Thus, for a newly extracted attribute a, the confidence score of the attribute a may be evaluated based on the extracted entities corresponding to an attribute column of the attribute a as:

$$S ( a ) = \frac{\# entities with the attribute}{\# entities sampled with not null value}$$

in which the number of entities with not null value is to be larger than a predetermined threshold. Accordingly, in various embodiments, each attribute with S(a)>threshold value may be determined to be confidently classified into the ontology 118. In at least one embodiment, the threshold value may be 0.98. However, the threshold value may be set to other numerical values in other embodiments.

Further, the attribute classification component 324 may also provide the one or more confidently classified attributes as training data to enrich the seed data 304. In at least one embodiment, the attribute classification component 324 may enrich the seed data 304 with the confidently classified attributes by adding the association between each confidently classified attribute and a corresponding entity to the entity-to-attribute index 316.

Returning to FIG. 2, the validation module 214 may perform the optional validation 112. In various embodiments, the validation 112 may include the comparison of the extracted entities 308 against the seed entities 124. For example, the seed entities 124 may be organized into a data table that includes rows of attribute data for multiple entities (e.g., movies) that are extracted from the selected web pages 116, as follows:

| Movie Name | Director | Release Date | Genre |
|---|---|---|---|
| Movie 1 | Name 1 | Date 1 | Genre 1 |
| Movie 2 | Name 2 | Date 2 | Genre 2 |
| . . . | . . . | . . . | . . . |

Further in the example, the extracted entities 308 may be likewise organized into another data table that includes rows of attribute data for multiple entities (e.g., movies) that are extracted from the web pages 120, as follows:

| Movie Name | Director | Release Date | Genre |
|---|---|---|---|
| Movie 1 | Name 0 | Date 1 | Genre 1 |
| Movie 2 | Name 2 | Date 2 | Genre 2 |
| . . . | . . . | . . . | . . . |

The data table of the seed entities 124 may serve as the ground truth for the comparison by the validation module 214. Accordingly, the validation module 214 may compare the attributes of the entities (e.g., movies) that appear in both the extracted entities 308 and the seed entities 124. As shown in the example, the validation module 214 may determine that the extracted entities 308 includes incorrect information for the entity “Movie 1”, as the extracted entities 308 indicates the director for the “Movie 1” is “Name 0” instead of “Name 1”, even though the remaining “Release Date” and “Genre” data” for “Movie 1” in the extracted entities 308 are correct. Thus, based on such comparisons, the validation module 214 may calculate a precision value and/or a recall value for the extracted entities 308.

The validation module 214 may further compare the precision value and/or the recall value with their respective value thresholds to validate the mapping of the attributes of the structured knowledge 122 to the ontology 118. For example, the validation module 214 may consider the mapping to be invalid when at least one of the precision value or the recall value fails to meet a corresponding threshold value. Otherwise, the validation module 214 may consider the mapping to be valid.

However, in scenarios in which the data scale of the extracted entities 308 exceeds a predetermined data scale threshold, the comparison of the extracted entities 308 against the seed entities 124 to calculate precision and/or recall may become impractical as such comparisons demand considerable computation and time resources. In at least one embodiment, the data scale of the extracted entities 308 may gradually exceed the predetermined data scale threshold as entities are extracted from more and more web pages. For example, the predetermined data scale threshold may be exceeded by the data scale of the extracted entities 308 when web pages from a certain number of websites (e.g., approximately 1000 websites) are analyzed by the knowledge extraction framework 202.

In such scenarios, the validation module 214 may enable the user to switch to manual sampling to determine the validity of the extracted entities 308, and consequently, the validity of the mapping of the structured knowledge 122 to the ontology 118. The manual sampling may involve the user manually checking a predetermined percentage of the extracted entities 308 to verify that the attribute values of such sampled entities are correct. For example, when a sampled entity is a movie, the user may manually verify that attributes such as director name, release date, and/or genre information are correct. The validation module 214 may enable the user to manually label each sampled entity with the result of the verification.

Once the predetermined percentage of the extracted entities 308 are manually labeled, the validation module 214 may once again calculate a precision value and/or a recall value for the extracted entities 308. Further, the precision value and/or the recall value may be further compared to their respective value thresholds to validate the mapping of the attributes of the structured knowledge 122 to the ontology 118. In various embodiments, the validation module 214 may cause the mapping of the structured knowledge 122 to the ontology 118 to be discarded if validation reveals that the mapping is invalid.

The annotation module 216 may perform the annotation 110 that annotates the structured knowledge 122 back into the web pages 120 with the ontology node names from the enriched ontology 118. The annotation 110 may produce the annotated web pages 126. The annotated web pages 126 may enable a search engine to extract structured knowledge in response to search queries rather than provide matching web pages as search results.

Thus, since the knowledge extraction framework 202 iteratively maps the structured knowledge 122 from each additional web page to the ontology 118, the ontology 118 may be continuously enriched. In turn, each enrichment of the ontology 118 improves the classification of newly extracted knowledge and the annotation of the web pages from which the knowledge is extracted.

The user interface module 218 may enable a user to interact with the modules of the knowledge extraction framework 202 using a user interface (not shown). The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

In various embodiments, the user interface module 218 may enable the user to input the manual labels 114, select the web pages 116 and the web pages 120, define one or more manual rules 222, manually check and label the mapping results, and/or so forth. In various embodiments, the manual rules 222 may include at least one string matching rule, at least one regular expression, and/or at least one attribute type taxonomy.

The data store 220 may store the inputs, rules, and data that are used by the modules of the knowledge extraction framework 202. In at least one embodiment, the data store may store the manual labels 114, the structured knowledge 122, the seed entities 124, the manual rules 222, and/or so forth. The data store may further store the data and knowledge that are described with respect to FIG. 3.

### Example Processes

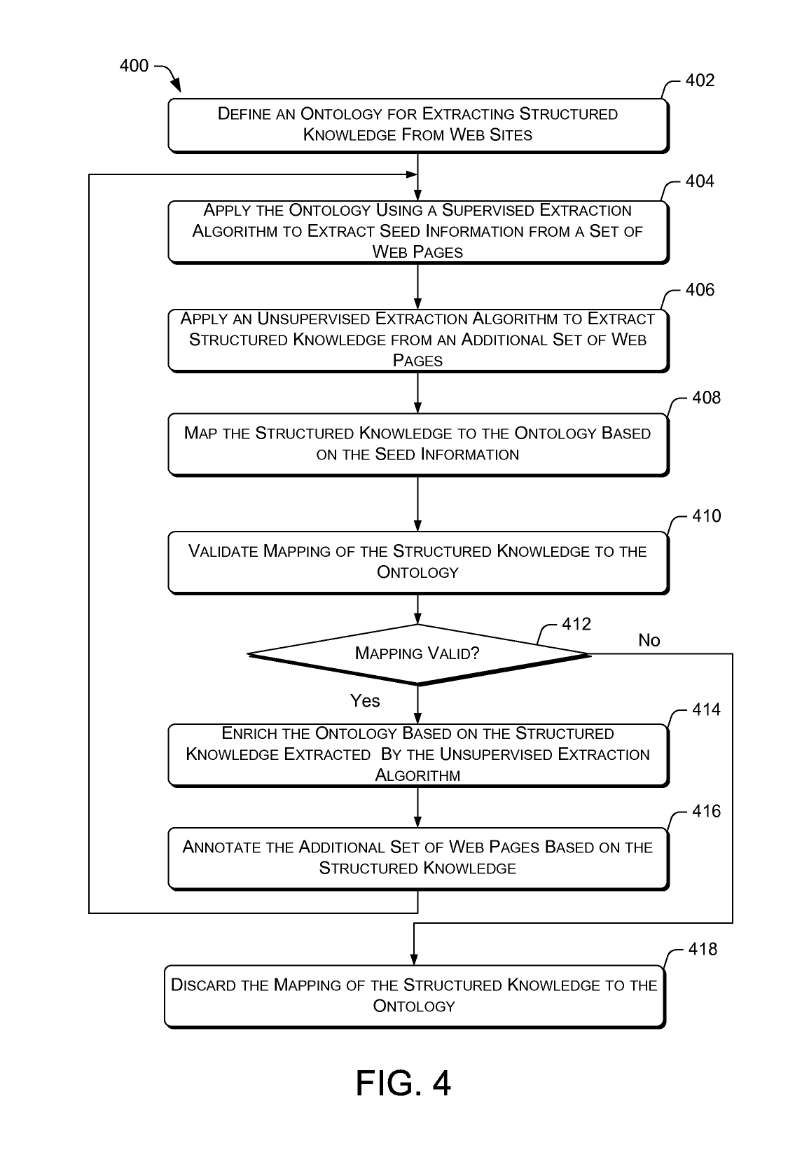

FIGS. 4-6 describe various example processes for a framework that extracts structured knowledge from semi-structured web pages. The order in which the operations are described in each example process is not intended to be construed as a limitation, and any number of the described operations can be combined in any order and/or in parallel to implement each process. Moreover, the operations in each of the FIGS. 4-6 may be implemented in hardware, software, and a combination thereof. In the context of software, the operations represent computer-executable instructions that, when executed by one or more processors, cause one or more processors to perform the recited operations. Generally, computer-executable instructions include routines, programs, objects, components, data structures, and so forth that cause the particular functions to be performed or particular abstract data types to be implemented.

FIG. 4 is a flow diagram that illustrates an example process 400 for enriching the ontology that is used to extract structured knowledge from semi-structured web pages. At block 402, an ontology 118 for extracting structured knowledge from websites may be defined. The ontology 118 may be defined based on the manual labels that a user assigns to one or more web pages.

At block 404, the supervised learning module 208 may apply the ontology using a supervised extraction algorithm to extract seed information from a set of web pages, such as the selected web pages 116. The extracted seed information may be in the form of seed entities 124. Each of the seed entities 124 may include one or more attributes.

At block 406, the unsupervised learning module 210 may apply an unsupervised extraction algorithm to extract structured knowledge 122 from an additional set of web pages, such as the web pages 120. In various embodiments, the web pages 120 may include the selected web pages 116 and/or additional web pages that belong in the same domain as the web pages 116.

At block 408, the mapping module 212 may map the structured knowledge 122 to the ontology 118 based on the seed information. In various embodiments, the mapping module 212 may use exact matching, manual rules, and learned pattern rules to produce precise mapping of the extracted structured knowledge 122 to the ontology 118.

At decision block 412, the validation module 214 may determine whether the mapping results are valid. In various embodiments, the validation may include the comparison of the structured knowledge 122 against the seed entities 124 to determine validity of the data extracted by the unsupervised learning extraction 106, or the random manual sampling and checking of a predetermined percentage of the structured knowledge 122 for validity of the extracted data.

Thus, if the mapping is determined to be valid (“yes” at decision block 412), the process 400 may continue to block 414. At block 414, the mapping module 212 may enrich the ontology 118 based on the structured knowledge 122 extracted by the unsupervised extraction algorithm of the unsupervised learning module 210. The enrichment of the ontology 118 may improve the classification of additional extracted structured knowledge into the ontology 118.

At block 416, the annotation module 216 may annotate the structured knowledge 122 back into the additional set of web pages, such as the web pages 120, with the ontology node names from the enriched ontology 118 to produce the annotated web pages 126. The annotated web pages 126 may enable a search engine to extract structured knowledge in response to search queries rather than provide matching web pages as search results.

However, returning to decision block 412, if the mapping is determined to be invalid (“no” at decision block 412), the process 400 may continue to block 418. At block 418, the mapping module 212 may discard the mapping of the structured knowledge 122 to the ontology 118.

In alternative embodiments, the operations described with respect to the block 410 and the decision block 412 may be optional. In such embodiments, the enrichment of the ontology 118 based on the structured knowledge 122 extracted by the unsupervised learning module 210 may take place directly after the mapping of the structured knowledge 122 to the ontology 118.

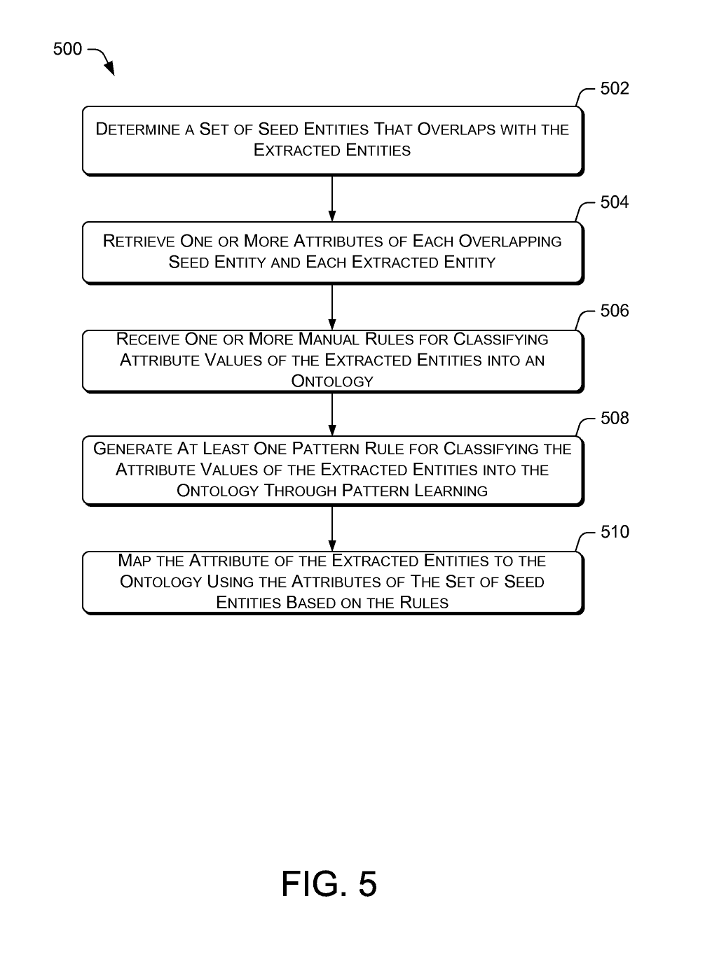

FIG. 5 is a flow diagram that illustrates an example process 500 for mapping extracted entities 308 to the ontology 118 to enrich the ontology 118. The process 500 may further describe the block 408 of the process 400. At block 502, the entity sampling component 306 of the mapping module 212 may determine a set of one or more seed entities from the seed entities 124 that overlaps with the extracted entities 308. A seed entity overlaps when the seed entity has a corresponding counterpart entity in the extracted entities 308, although the seed entity and the counterpart entity may have different attributes and/or attribute values.

At block 504, the attribute retrieval component 312 may retrieve one or more attributes of each overlapping seed entity 310 and each extracted entity 308. In various embodiments, the attribute retrieval component 312 may retrieve the attribute values from the extracted attribute columns 314. The extracted attribute columns 314 are attribute columns in the one or more entities of the extracted entities 308. Accordingly, the attribute values retrieved from the extracted attribute columns 314 may be referred to as the extracted entity knowledge 318.

Further, the attribute retrieval component 312 may retrieve the attribute names and attribute values of the one or more overlapping seed entities 310. The attribute names and the attribute values retrieved from the one or more overlapping seed entities 310 may be referred to as the stored entity knowledge 320.

At block 506, the manual rule component 322 may receive one or more manually inputted rules that are used by the attribute classification component 324 to classify the extracted entity knowledge 318 into the ontology 118 based on the stored entity knowledge 320. The rules may reflect human knowledge or insight about the seed entities 124. The manually inputted rules may include manual definitions of at least one string matching rule, at least one regular expression, and/or at least one attribute type taxonomy that facilitate classification.

At block 508, the pattern learning component 326 may generate one or more pattern rules that are used by the attribute classification component 324 to classify the extracted entity knowledge 318 into the ontology 118 based on the stored entity knowledge 320. In various embodiments, the pattern learning component 326 may use machine learning to automatically determine the pattern rules.

At block 510, the attribute classification component 324 may map the attributes of the extracted entities 308 to the ontology 118 using the attributes of the seed entities 124. In various embodiments, such mapping may be implemented by classifying the extracted entity knowledge 318 to the ontology 118 based on the stored entity knowledge 320. In various embodiments, the attribute classification component 324 may use exact matching, the manual rules, and the learned pattern rules to produce precise mapping of the extracted entity knowledge 318 to the ontology 118.

In some embodiments, the confidence ranking component 328 may evaluate the mapping of the one or more attributes to the ontology 118 to determine whether the attribute is confidently classified. Accordingly, if all the entities corresponding to an attribute are well matched to the ontology 118, then the confidence ranking component 328 may determine that the attribute is confidently classified. Otherwise, the mapping of the attribute to the ontology 118 may be discarded by the attribute classification component 324.

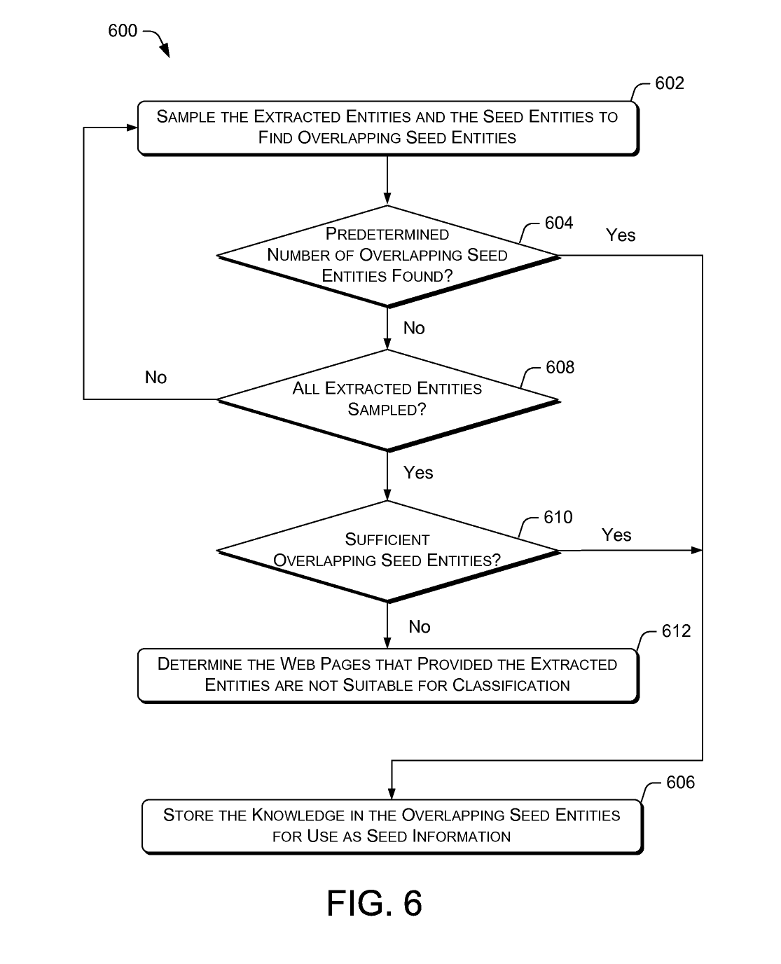

FIG. 6 is a flow diagram that illustrates an example process 600 for determining the overlapping seed entities 310 that provide seed information for mapping the extracted entities to the ontology. The process 600 may further describe the block 502 of the process 500. At block 602, the entity sampling component 306 may sample the extracted entities 308 and the seed entities 124 to find overlapping entities. At decision block 604, the entity sampling component 306 may determine whether a predetermined number of the overlapping seed entities 310 has been found. If the entity sampling component 306 determines that the predetermined number of the overlapping seed entities 310 has been found (“yes” at decision block 604), the process 600 may proceed to block 606. At block 606, the entity sampling component 306 may store the knowledge from the overlapping seed entities 310 for use as seed information for mapping. In various embodiments, the knowledge may include the attribute values from the extracted attribute columns 314 of the overlapping seed entities 310.

However, if the entity sampling component 306 determines that the predetermined number of the overlapping seed entities 310 has not been found (“no” at decision block 604), the process 600 may proceed to decision block 608.

At decision block 608, the entity sampling component 306 may determine whether all of the extracted entities 308 have been sampled for comparison with the seed entities 124. If the entity sampling component 306 determines that not all of the extracted entities 308 have been sampled (“no” at decision block 608), the process 600 may loop back to block 602 so that additional sampling may occur. However, if the entity sampling component 306 determines that all of the extracted entities 308 have been sampled, the process 600 may continue to decision block 610.

At decision block 610, the entity sampling component 306 may determine whether a sufficient number of the overlapping seed entities 310 has been found. In at least one embodiment, the entity sampling component 306 may determine that there is an insufficient number of the overlapping seed entities 310 found when a complete sampling of the extracted entities 308 based on the seed entities 124 failed to reveal a minimal threshold number of the overlapping seed entities 310. Thus, if the entity sampling component 306 determines that there are not a sufficient number of the overlapping seed entities 310 found (“no” at decision block 610), the process 600 may proceed to block 612. At block 612, the entity sampling component 306 may determine that the web pages that provided the extracted entities 308 are not suitable for classification into the ontology 118. Accordingly, the mapping module 212 may abandon the mapping of the extracted entities 308 into the ontology 118.

However, if the entity sampling component 306 determines that there is a sufficient number of the overlapping seed entities 310 found (“yes” at decision block 610), the process 600 may also continue to block 606. In various embodiments, the entity sampling component 306 may determine that there is sufficient number of the overlapping seed entities 310 when the number of the overlapping seed entities 310 meets or exceeds the minimal threshold number. Once again, at block 606, the entity sampling component 306 may store the knowledge from the overlapping seed entities 310 for use as seed information.

By leveraging the supervised and the unsupervised knowledge extraction algorithms, the knowledge extraction framework may iteratively improve the ontology that is used to classify knowledge obtained from each new semi-structured web page based on knowledge obtained from previous semi-structured web pages. As a result, the framework may have the ability to adapt to data structure changes and/or new data structures of semi-structured web pages during structured knowledge extraction.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

What is claimed is:

1. A computer-implemented method, comprising:
defining an ontology for extracting structured knowledge from a plurality of web pages;
applying the ontology using a supervised extraction algorithm to obtain seed information from a set of web pages;
applying an unsupervised extraction algorithm to extract the structured knowledge from an additional set of web pages; and
mapping the structured knowledge to the ontology based at least on the seed information to produce an enriched ontology.

2. The computer-implemented method of claim 1, further comprising annotating the additional set of web pages with the structured knowledge using the enriched ontology.

3. The computer-implemented method of claim 1, wherein the mapping further comprises:
determining a set of one or more overlapping seed entities included in the seed information that overlaps with one or more extracted entities included in the structured knowledge;
retrieving at least one attribute of each overlapping seed entity and each of extracted entities included in the structured knowledge; and
mapping attributes of the extracted entities to the ontology by classifying attribute values of the extracted entities to the ontology using an attribute name and an attribute value of the each overlapping seed entity.

4. The computer-implemented method of claim 3, further comprising receiving a manually defined rule, and wherein the mapping includes classifying the attribute values to the ontology based at least on the manually defined rule.

5. The computer-implemented method of claim 4, wherein the manually defined rule is a string matching rule, a regular expression, or an attribute type taxonomy for classifying an attribute.

6. The computer-implemented method of claim 5, wherein the manually defined rule is the attribute type taxonomy, and the attribute type taxonomy includes definitions for numerical attributes, enumerable attributes, and free text attributes.

7. The computer-implemented method of claim 3, further comprising automatically generating a pattern rule via an analysis of at least the attributes of the extracted entities, and wherein the mapping includes classifying the attribute values to the ontology based at least on the pattern rule.

8. The computer-implemented method of claim 3, further comprising:
determining a confidence score for an attribute that is mapped to the ontology; and
discarding mapping of the attribute to the ontology when the confidence score fails to exceed a predetermined threshold.

9. The computer-implemented method of claim 8, wherein the confidence score for the attribute is calculated based at least on extracted entities corresponding to an attribute column that lists values of the attribute.

10. The computer-implemented method of claim 3, further comprising:
building an index that associates a plurality of overlapping seed entities with corresponding attributes; and
enriching the seed information by adding an association between an attribute that is mapped to the ontology and a corresponding entity to the index.

11. The computer-implemented method of claim 3, wherein the determining including terminating sampling of the extracted entities included in the structured knowledge when a predetermined number of the one or more overlapping seed entities is discovered.

12. A computer-readable medium storing computer-executable instructions that, when executed, cause one or more processors to perform acts comprising:
defining an ontology for extracting structured knowledge from a plurality of web pages;
applying the ontology using a supervised extraction algorithm to obtain seed entities from a set of web pages;
applying an unsupervised extraction algorithm to obtain extracted entities from an additional set of web pages;
determining a set of overlapping seed entities included in the seed entities that overlaps with the extracted entities;
retrieving at least one attribute of each overlapping seed entity and each of the extracted entities, each attribute including an attribute name and an attribute value; and
mapping attributes of the extracted entities to the ontology to produce an enriched ontology.

13. The computer-readable medium of claim 12, further comprising validating the mapping based at least on at least one of a precision value or a recall value that is obtained from a comparison of the seed entities to the extracted entities or a manual labeling of the extracted entities.

14. The computer-readable medium of claim 12, further comprising annotating the additional set of web pages with ontology node names from the enriched ontology.

15. The computer-readable medium of claim 12, wherein the mapping includes classifying attribute values of the extracted entities to the ontology using the attribute name and attribute value of the each overlapping seed entity.

16. The computer-readable medium of claim 14, further comprising:
receiving a manually defined rule that is a matching rule, a regular expression, or an attribute type taxonomy for classifying an attribute; and
generating a pattern rule via an analysis of at least the attributes of the extracted entities,
and wherein the mapping includes classifying the attributes values to the ontology based at least on at least one of the manually defined rule or the pattern rule.

17. The computer-readable medium of claim 12, further comprising:
determining a confidence score for an attribute that is mapped to the ontology, the confidence score being calculated using extracted entities corresponding to an attribute column that lists values of the attribute; and
discarding mapping of the attribute to the ontology when the confidence score fails to exceed a predetermined threshold.

18. A computing device, comprising:
one or more processors; and
a memory that includes a plurality of computer-executable components of a knowledge extraction framework, the plurality of computer-executable components comprising:
a supervised learning module that applies a predefined ontology using a supervised extraction algorithm to extract seed information from a set of web pages;
an unsupervised learning module that applies an unsupervised extraction algorithm to extract structured knowledge from an additional set of web pages;
a mapping module that maps the structured knowledge to the ontology based at least on the seed information to enrich the ontology; and
an annotation module that annotates the additional set of web pages based at least on the structured knowledge.

19. The computing device of claim 18, wherein the mapping module maps the structured knowledge to the ontology by:
determining a set of one or more overlapping seed entities included in the seed information that overlaps with one or more extracted entities included in the structured knowledge;
retrieving at least one attribute of each overlapping seed entity and each of extracted entities included in the structured knowledge, each attribute including an attribute name and an attribute value; and
mapping attributes of the extracted entities to the ontology by classifying attribute values of the extracted entities to the ontology using the attribute name and attribute value of the each overlapping seed entity.

20. The computing device of claim 19, wherein the mapping module is to further:
receive a manually defined rule that is a string matching rule, a regular expression, or an attribute type taxonomy for classifying an attribute; and
generate a pattern rule via an analysis of at least the attributes of the extracted entities,
and wherein the mapping includes classifying the attributes values to the ontology based at least on at least one of the manually defined rule or the pattern rule.
